(19) United States
(12) Patent Application Publication
(10) Pub. No.: US 2026/0100522 A1
(43) Pub. Date: Apr. 9, 2026

(54) ELECTRICAL CONNECTION UNIT

(71) Applicant: YAZAKI CORPORATION, Tokyo (JP)

(72) Inventors: Ryu Senoo, Kakegawa-shi (JP); Hirotaka Mukasa, Kakegawa-shi (JP); Kazuhiko Tsuchiya, Kakegawa-shi (JP)

(21) Appl. No.: 19/347,775

(22) Filed: Oct. 2, 2025

(30) Foreign Application Priority Data
Oct. 7, 2024 (JP) 2024-175985

(51) Int. Cl. H01R 4/30; H02G 3/16

(52) U.S. Cl. CPC H01R 4/30; H02G 3/16

(57) ABSTRACT

An electrical connection unit includes an electronic component including a first terminal, an insulating base member including a plate-shaped or sheet-shaped flat surface portion including a surface facing the electronic component, and a first bus bar supported by the flat surface portion, electrically connected to the electronic component, and including a first plate portion and a first bent portion, in which the first plate portion includes a first connection portion electrically connected to the first terminal, and the first bent portion is bent from the first plate portion in a direction intersecting the surface at a position aligned with the first connection portion.

### TECHNICAL FIELD

Embodiments of the present invention relate to an electrical connection unit.

Priority is claimed on Japanese Patent Application No. 2024-175985 filed in Japan on Oct. 7, 2024, the content of which is incorporated herein by reference.

### BACKGROUND ART

An electrical connection unit having an electronic component and a bus bar electrically connected to the electronic component is known.

### PRIOR ART DOCUMENT

### Patent Document

[Patent Document 1] Japanese Unexamined Patent Application, First Publication No. 2024-037492

### SUMMARY OF THE INVENTION

### Problems to be Solved by the Invention

Incidentally, it is expected to improve a heat dissipation property of an electrical connection unit.

An embodiment provides an electrical connection unit capable of improving a heat dissipation property.

### Means for Solving the Problem

An electrical connection unit according to an embodiment includes an electronic component including a first terminal, an insulating base member including a plate-shaped or sheet-shaped flat surface portion including a surface facing the electronic component, and a first bus bar supported by the flat surface portion, electrically connected to the electronic component, and including a first plate portion and a first bent portion, in which the first plate portion includes a first connection portion electrically connected to the first terminal, and the first bent portion is bent from the first plate portion in a direction intersecting the surface at a position aligned with the first connection portion.

### Effects of Invention

According to one embodiment, it is possible to improve the heat dissipation property.

### BRIEF DESCRIPTION OF THE DRAWINGS

FIG. 1 A cross-sectional view illustrating an electrical connection unit of an embodiment.

FIG. 2 A perspective view for describing a main body of the embodiment.

FIG. 3 A perspective view for describing one subunit of the embodiment.

FIG. 4 A perspective view illustrating an electronic component and a connection component of the embodiment.

FIG. 5 A partially exploded perspective view of a routing board of the embodiment.

FIG. 6 An enlarged plan view of the electrical connection unit in F6 illustrated in FIG. 3.

FIG. 7 An enlarged plan view of one electronic component in FIG. 6 in a see-through manner.

FIG. 8 A cross-sectional view of the electrical connection unit taken along line F8-F8 illustrated in FIG. 3.

FIG. 9 A cross-sectional view of the electrical connection unit taken along line F9-F9 illustrated in FIG. 3.

FIG. 10 A cross-sectional view of the electrical connection unit taken along line F10-F10 illustrated in FIG. 3.

FIG. 11 A perspective view for describing one subunit in a modification example of the embodiment.

### EMBODIMENTS FOR CARRYING OUT THE INVENTION

Hereinafter, embodiments will be described with reference to the drawings. In the following description, constitutions having the same or similar functions are denoted by the same reference numbers. Redundant descriptions of these constitutions may be omitted. Note that the constitution described below does not limit the scope of the embodiment.

In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “accommodation” is not limited to a case where the entire component is accommodated, and may include a case where only a part of the component is accommodated (a state in which the remaining part of the component protrudes). The term “facing” indicates that virtual projection images of two target objects overlap each other when viewed from a specific direction. That is, the term “facing” is not limited to a case where two target objects directly face each other, and may include a case where two target objects face each other in a state in which another member exists between the two target objects. “Parallel”, “orthogonal”, or “the same” may include “substantially parallel”, “substantially orthogonal”, or “substantially the same”, respectively.

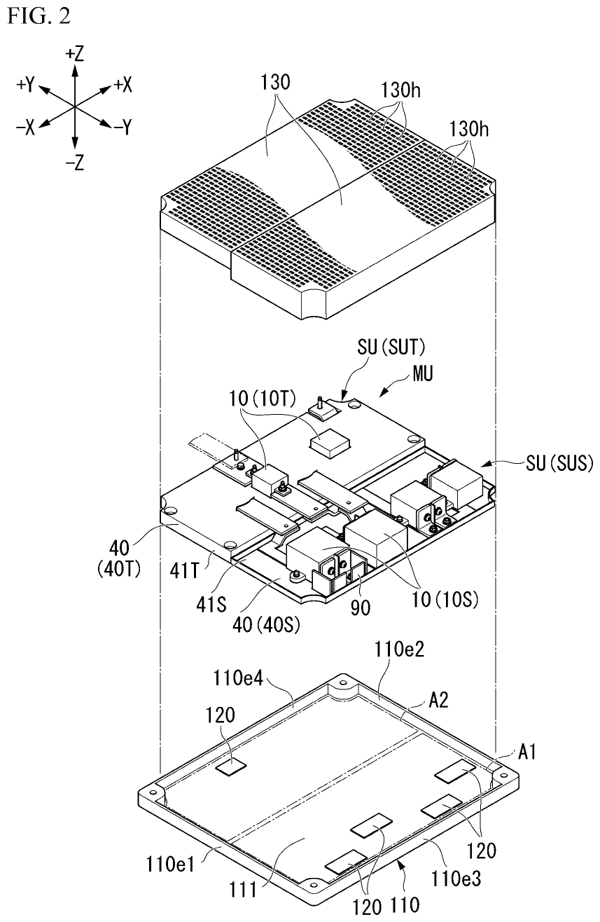

In the present disclosure, a +X direction, a −X direction, a +Y direction, a −Y direction, a +Z direction, and a −Z direction are defined as follows. The +X direction is a direction from a first end 110e1 to a second end 110e2 of a metal plate 110 that will be described later (see FIG. 2). The −X direction is a direction opposite to the +X direction. Hereinafter, in a case where the +X direction and the −X direction are not distinguished, the directions will be simply referred to as “X direction”. The +Y direction and the −Y direction are directions intersecting (for example, orthogonal to) the X direction. The +Y direction is a direction from a third end 110e3 to a fourth end 110e4 of the metal plate 110 that will be described later (see FIG. 2). The −Y direction is a direction opposite to the +Y direction. Hereinafter, in a case where the +Y direction and the −Y direction are not distinguished, the directions will be simply referred to as “Y direction”. The +Z direction and the-Z direction are directions intersecting (for example, orthogonal to) the X direction and the Y direction. The +Z direction is a direction from the metal plate 110 that will be described later toward a main body MU (see FIG. 2). The −Z direction is a direction opposite to the +Z direction. Hereinafter, in a case where the +Z direction and the −Z direction are not distinguished, the directions will be simply referred to as “Z direction”. The Z direction is an example of a “first direction”. The Y direction is an example of a “second direction”. The X direction is an example of a “third direction”.

Hereinafter, in a case where the X direction and the Y direction are not distinguished, the directions may be referred to as “horizontal direction”. Hereinafter, the Z direction may be referred to as “vertical direction”. Hereinafter, the +Z direction side may be referred to as “upper”, and the −Z direction side may be referred to as “lower”. However, these expressions are expressions for convenience of description, and do not limit a gravity direction of an electrical connection unit 1 (an installation posture of the electrical connection unit 1).

### EMBODIMENT

### 1. CONSTITUTION OF ELECTRICAL CONNECTION UNIT

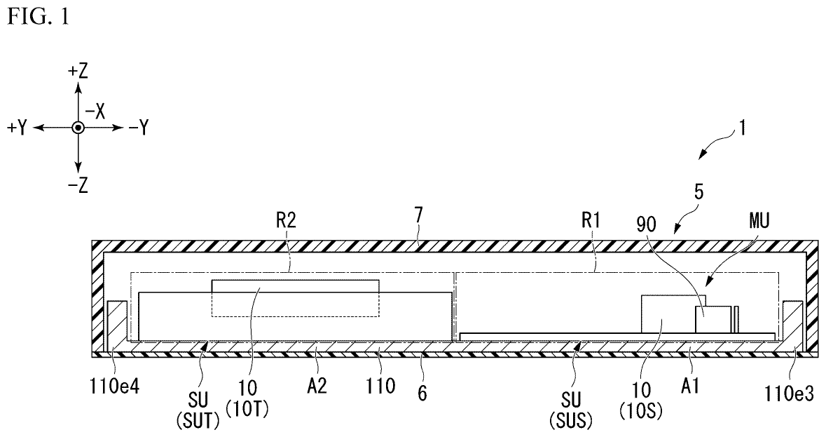

FIG. 1 is a cross-sectional view illustrating an electrical connection unit 1 of an embodiment. The electrical connection unit 1 is, for example, an in-vehicle device mounted on a vehicle such as an electric vehicle (EV), a hybrid electric vehicle (HEV), or a plug-in hybrid electric vehicle (PHEV). The electrical connection unit 1 may be referred to as an “electrical connection box” or a “junction box”, for example. However, the electrical connection unit 1 is not limited to a box-shaped device.

The electrical connection unit 1 includes, for example, a casing 5, a main body MU, a metal plate 110, a plurality of heat transfer members 120 (see FIG. 2), and a plurality of insulating covers 130 (see FIG. 2).

### 2. CASING

First, the casing 5 will be described. The casing 5 forms an outline of the electrical connection unit 1. The casing 5 includes, for example, a base 6 (first member) and a cover 7 (second member). The base 6 is a member that covers the main body MU and the metal plate 110 from below. The base 6 has, for example, a plate shape formed in the horizontal direction or a bowl shape open in the +Z direction. The base 6 is made of, for example, a synthetic resin. The cover 7 is a member that covers the main body MU and the metal plate 110 from above. The base 6 has, for example, a bowl shape open in the −Z direction. The cover 7 is made of, for example, a synthetic resin. In the present embodiment, the box-shaped casing 5 is formed by combining the base 6 and the cover 7. The shape of the casing 5 is not limited to the above example. For example, the metal plate 110 that will be described later may function as a part or the whole of the base 6. The casing 5 may be omitted.

In the present embodiment, the electrical connection unit 1 includes a first region (first space) R1 and a second region (second space) R2. The first region R1 is a region in which a heat dissipation property is emphasized. In the first region R1, for example, an electronic component 10S having a great amount of heat generation is disposed. On the other hand, the second region R2 is a region in which mountability is emphasized. In the second region R2, for example, an electronic component 10T that has a smaller amount of heat generation than the electronic component 10S and/or requires a more complicated mounting structure than the electronic component 10S is disposed. However, these contents do not limit the contents of the electrical connection unit 1 of the present disclosure. For example, the amount of heat generation of the electronic component 10T may be greater than the amount of heat generation of the electronic component 10S.

### 3. MAIN BODY

### Next, the Main Body Mu Will Be Described.

FIG. 2 is a perspective view for describing the main body MU. The main body MU is a portion that performs a main function (for example, switching of electrical connection states or overcurrent protection) of the electrical connection unit 1. In the present embodiment, the main body MU is divided into a plurality of subunits SU. The main body MU is formed by connecting the plurality of subunits SU, for example. In the present embodiment, the main body MU includes two subunits SU (subunits SUS and SUT). Each subunit SU may be referred to as a “circuit constitution body”.

The subunit SUS has an electrical first function. The subunit SUS includes, for example, a plurality of electronic components 10S and a routing board 40S. The plurality of electronic components 10S are electrically connected to the routing board 40S. The base plate 41S (that will be described later) included in the subunit SUS is an example of a “first base member”.

The subunit SUT has an electrical second function. The second function is a function different from the first function. The subunit SUT includes, for example, a plurality of electronic components 10T and a routing structure 40T. The plurality of electronic components 10T are electrically connected to the routing structure 40T. The base member 41T (that will be described later) included in the subunit SUT is an example of a “second base member”.

In the present embodiment, the subunit SUS is a subunit SU in which a heat dissipation property is emphasized. The subunit SUS is disposed in the above first region R1 of the electrical connection unit 1. The subunit SUS faces a first region A1 of the metal plate 110 that will be described later in the Z direction.

On the other hand, the subunit SUT is a subunit SU in which mountability is emphasized. The subunit SUT is disposed, for example, on the +Y direction side with respect to the subunit SUS. The subunit SUT is disposed in the above second region R2 of the electrical connection unit 1. The subunit SUT faces a second region A2 of the metal plate 110 that will be described later in the Z direction. Hereinafter, in a case where the electronic component 10S and the electronic component 10T are not distinguished, the electronic components are simply referred to as “electronic component 10”.

Note that the main body MU need not be divided into a plurality of subunits SU instead of the example described above. For example, the plurality of subunits SU may be integrally formed. For example, the base plate 41S of the routing board 40S and the base member 41T of the routing structure 40T may be integrally formed by one piece member. Note that the base member 41T of the routing structure 40T has a three-dimensional structure thicker in the Z direction, compared to the base plate 41S of the routing board 40S. In a case where the routing board 40S and the routing structure 40T are not distinguished from each other, the routing board 40S and the routing structure 40T may be simply referred to as “routing structure 40”.

### 4. CONSTITUTION OF SUBUNIT SUS

Next, a constitution of the subunit SUS will be described.

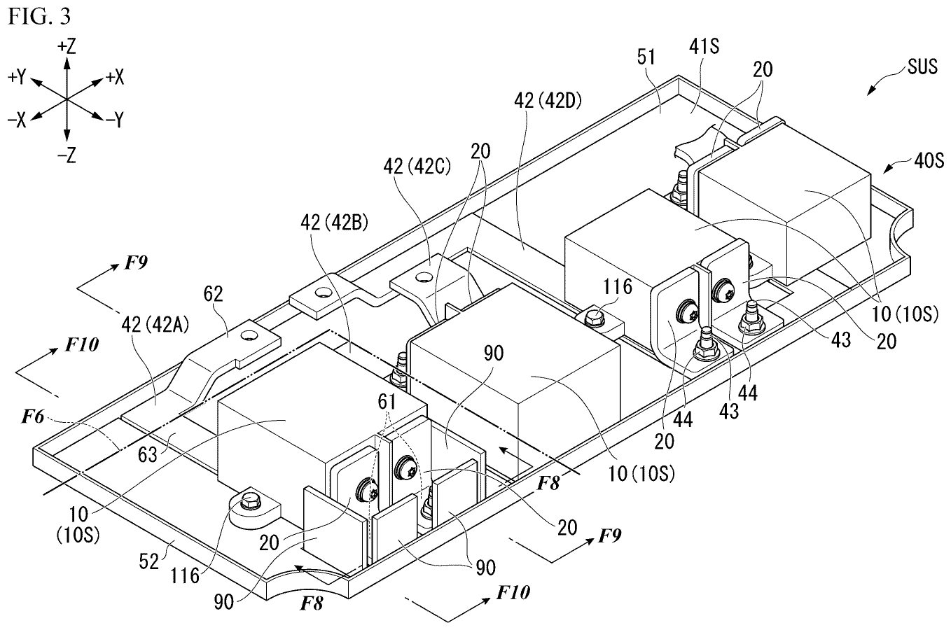

FIG. 3 is a perspective view for describing the subunit SUS. The subunit SUS includes, for example, a plurality of electronic components 10, a plurality of connection components 20, and a routing board 40S. The connection component 20 is a member forming an energization path in the vertical direction. The connection component 20 may be referred to as a “vertical routing member”.

### 4.1 Electronic Component

First, the electronic component 10 will be described. The electronic component 10 is an electronic component mounted according to a function required for each subunit SU. The electronic component 10 is, for example, a connector, a fuse, a relay (for example, a mechanical relay or a semiconductor relay), a capacitor, a branch component, any of various sensors (for example, a current sensor or a voltage sensor), an electronic control unit, or an electronic component unit in which two or more of these are unitized. However, the type of the electronic component 10 is not limited to the above example.

The electronic component 10 is, for example, a heat generating component that generates heat at the time of energization.

In the present embodiment, the plurality of electronic components 10 include an electronic component 10S that generates relatively large heat when energized. The electronic component 10S is a relay (for example, a mechanical relay or a semiconductor relay), a pyrofuse, a current sensor (for example, a current sensor having a shunt resistor), or the like. However, the type of the electronic component 10S is not limited to the above example.

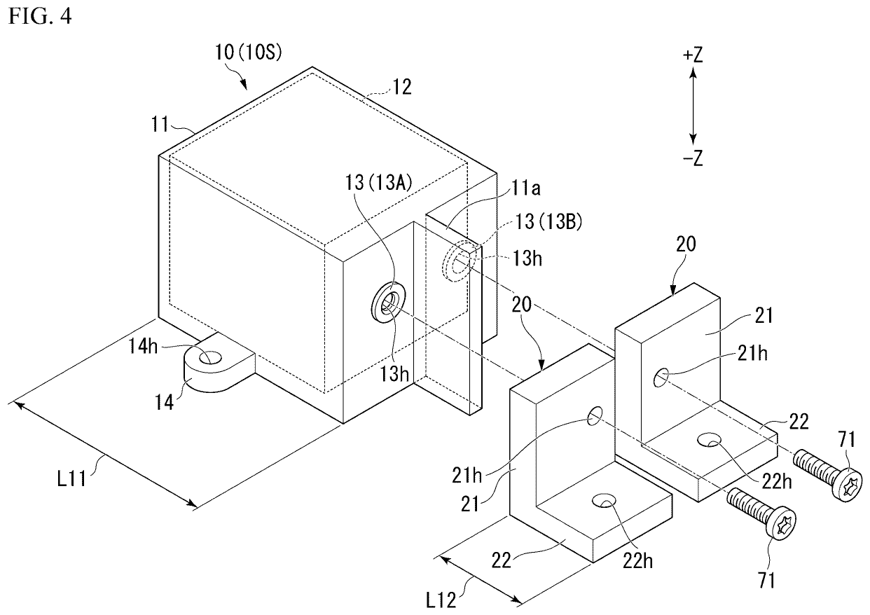

FIG. 4 is a perspective view illustrating the electronic component 10S and the connection component 20. The electronic component 10S is, for example, an electronic component in which a plurality of terminals 13 are disposed to be arranged at one end of the electronic component 10S. The electronic component 10S includes, for example, a case 11, a component body 12, a plurality of terminals 13, and a plurality of attachment portions 14.

### (Case)

The case 11 is an outer member that forms most of the outer shape of the electronic component 10S. The case 11 is made of, for example, synthetic resin and has an insulating property. The case 11 accommodates the component body 12. The case 11 and the component body 12 may be integrally formed.

In the present embodiment, the case 11 has an insulating rib 11a protruding in the horizontal direction (for example, the Y direction) and extending in the Z direction. The insulating rib 11a has, for example, a plate shape formed in the horizontal direction (for example, the Y direction) and the Z direction. The insulating rib 11a extends over the entire length of the case 11 in the Z direction, for example. The insulating rib 11a is disposed between the plurality of terminals 13 (a terminal 13A and a terminal 13B that will be described later). The insulating rib 11a electrically insulates the terminal 13A from the terminal 13B. In the present embodiment, a part of the insulating rib 11a is disposed between first portions 21 (that will be described later) of the two connection components 20 connected to the electronic component 10S. The insulating rib 11a electrically insulates between the first portions 21 of the two connection components 20 connected to the electronic component 10S.

### (Component Body)

The component body 12 is a portion that performs a main function of the electronic component 10S. For example, in a case where the electronic component 10S is a relay, the component body 12 includes a switch (for example, a contact) that switches between a conductive state and a non-conductive state. For example, in a case where the electronic component 10S is a fuse, the component body 12 includes a fusion portion that is fused when an overcurrent flows. For example, in a case where the electronic component 10S is a capacitor, the component body 12 includes a portion that accumulates electric charge.

### (Terminal)

The terminal 13 is an electrical connection portion exposed to the outside of the case 11. The terminal 13 is electrically connected to the component body 12 inside the case 11. In the present embodiment, the electronic component 10S includes a terminal 13A and a terminal 13B as the plurality of terminals 13. One of the terminal 13A and the terminal 13B is a terminal on the positive electrode side. The other of the terminal 13A and the terminal 13B is a terminal on the negative electrode side. The terminal 13A is an example of a “first terminal”. The terminal 13B is an example of a “second terminal”.

In the present embodiment, the terminal 13A and the terminal 13B are provided at one end of the electronic component 10S in the horizontal direction (for example, the Y direction). The terminal 13A and the terminal 13B are disposed to be arranged in the horizontal direction (for example, the X direction). Each of the terminal 13A and the terminal 13B is directed in the horizontal direction (for example, the Y direction). Each terminal 13 has an attachment hole 13h to which a fastening member 71 (for example, a screw or a bolt) that will be described later is attached. The attachment hole 13h is open in the horizontal direction (for example, the Y direction). An inner circumferential surface of the attachment hole 13h of the electronic component 10S has a screw groove.

### (Attachment Portion)

The attachment portion 14 is a portion for fixing the electronic component 10S. The attachment portion 14 has an attachment hole 14h to which the fastening member 116 (see e.g. screw or bolt, FIG. 3) is attached. The attachment hole 14h is open in the Z direction. The attachment hole 14h is an insertion hole through which the fastening member 116 passes. A fixing destination of the attachment portion 14 will be described later.

### 4.2 Connection Component

Next, the connection component 20 will be described. The connection component 20 is a component that electrically connects the electronic component 10S to the routing board 40S. The connection component 20 forms a part of an energization path in the subunit SUS. The connection component 20 is made of metal (for example, made of copper, made of a copper alloy, made of aluminum, or made of an aluminum alloy). The connection component 20 may be referred to as a “metal component”.

In the present embodiment, the connection component 20 electrically connects the electronic component 10S to the bus bar 42 (see FIG. 3) included in the routing board 40S. In the present embodiment, a length L12 of the connection component 20 in the longitudinal direction (for example, the Y direction) of the electronic component 10S is smaller than a length L11 of the electronic component 10S in the longitudinal direction. The connection component 20 includes, for example, a first portion 21 and a second portion 22.

### (First Portion)

The first portion 21 of the connection component 20 is a portion connected to the terminal 13 of the electronic component 10S. The first portion 21 is a plate-shaped or rectangular parallelepiped portion extending in the Z direction. The first portion 21 extends in the Z direction along one end (for example, an end in the Y direction) of the electronic component 10S. The first portion 21 is a standing portion that stands in the Z direction with respect to the routing board 40S (for example, with respect to a bus bar 42 that will be described later). The first portion 21 is adjacent to the electronic component 10S in the horizontal direction (for example, the Y direction). For example, the first portion 21 is adjacent to the terminal 13 of the electronic component 10S in the horizontal direction (for example, the Y direction), and is connected to the terminal 13 of the electronic component 10S from the horizontal direction (for example, the Y direction).

The first portion 21 of the connection component 20 has a first attachment hole 21h through which the fastening member 71 (for example, a screw or a bolt) passes. The first attachment hole 21h is open in the horizontal direction (for example, the Y direction). The fastening member 71 that has passed through the first attachment hole 21h is engaged with the attachment hole 13h of the terminal 13 of the electronic component 10S, and thus the first portion 21 is physically and electrically connected to the terminal 13 of the electronic component 10S.

### (Second Portion)

The second portion 22 of the connection component 20 is a portion connected to the bus bar 42 (see FIG. 3). The second portion 22 protrudes in the horizontal direction (for example, the Y direction) from the end of the first portion 21 on the −Z direction side. The second portion 22 is a plate portion provided in the horizontal direction. The second portion 22 is adjacent to the bus bar 42 in the Z direction, and is connected to the bus bar 42 from the Z direction. The second portion 22 of the connection component 20 is attached to the fastening member 43 (for example, a screw or a bolt; and see FIG. 3) protruding from the bus bar 42 in the +Z direction from the Z direction, and is physically and electrically connected to the bus bar 42. In the present embodiment, the second portion 22 of the connection component 20 has a second attachment hole 22h through which the fastening member 43 passes. The second attachment hole 22h is open in the Z direction. In the second portion 22, the fastening member 43 passes through the second attachment hole 22h. An engagement member 44 (for example, a nut; and see FIG. 3) is engaged with the tip of the fastening member 43 that has passed through the second attachment hole 22h, and thus the second portion 22 is fixed to the bus bar 42. In the present embodiment, the first portion 21 and the second portion 22 form one L-shaped connection component 20.

In the present embodiment, the bus bar 42 is disposed at a position away from the terminal 13 of the electronic component 10S (for example, a position away in the Z direction). The connection component 20 is disposed between the electronic component 10S and the bus bar 42. In the present disclosure, the phrase “the connection component is disposed between the electronic component and the bus bar” is not limited to a case where a part of the connection component is located between the electronic component and the bus bar when viewed from the X direction or the Y direction. The phrase “the connection component is disposed between the electronic component and the bus bar” may correspond to a case where a part of the connection component is located between the electronic component and the bus bar when viewed from a direction inclined with respect to the X direction or the Y direction. The connection component 20 electrically connects the terminal 13 of the electronic component 10S to the bus bar 42.

### 4.3 Routing Board

### Next, the Routing Board 40S Will Be Described.

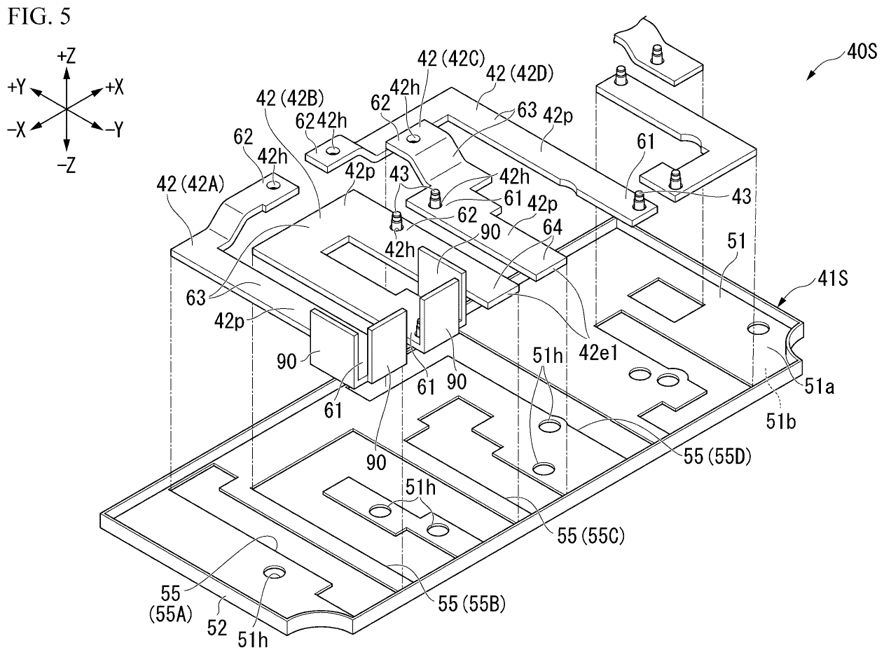

FIG. 5 is a perspective view for describing the routing board 40S. The routing board 40S is a member that forms at least a part of an energization path between a plurality of electronic components 10 (for example, a plurality of electronic components 10S) and/or at least a part of an energization path between the electronic component 10 (for example, the electronic component 10S) included in the subunit SUS and the electronic component 10 included in another subunit SU (for example, the subunit SUT). In the present disclosure, the “routing board”indicates a board-type routing structure. The “board type” indicates a plate shape along one plane when viewed as a whole regardless of a fine shape. In the present disclosure, the term “plate shape”, “sheet shape”, or “planar” is not limited to the case of being completely flat, and may include a case where a fixing structure, a rib, or the like protruding in the Z direction is partially present, a case where an uneven shape following the thickness of the bus bar is present on the surface, and the like. In the present embodiment, the routing board 40S has a plate shape formed in the X direction and the Y direction.

The routing board 40S includes, for example, a base plate 41S, one or more (for example, a plurality of) bus bars 42, and a plurality of fastening members 43. In the present embodiment, the base plate 41S and the plurality of bus bars 42 are integrated through insert molding. For example, the routing board 40S is formed as one piece member by insert-molding the bus bar 42 with the base plate 41S after the fastening member 43 is fixed to the bus bar 42. That is, the bus bar 42 is integrated with the base plate 41S without using a fastening member such as a screw or a bolt. Note that the routing board 40S may be formed by using another structure instead of the insert molding. A modification example in which the routing board 40S is formed by using another structure will be described later.

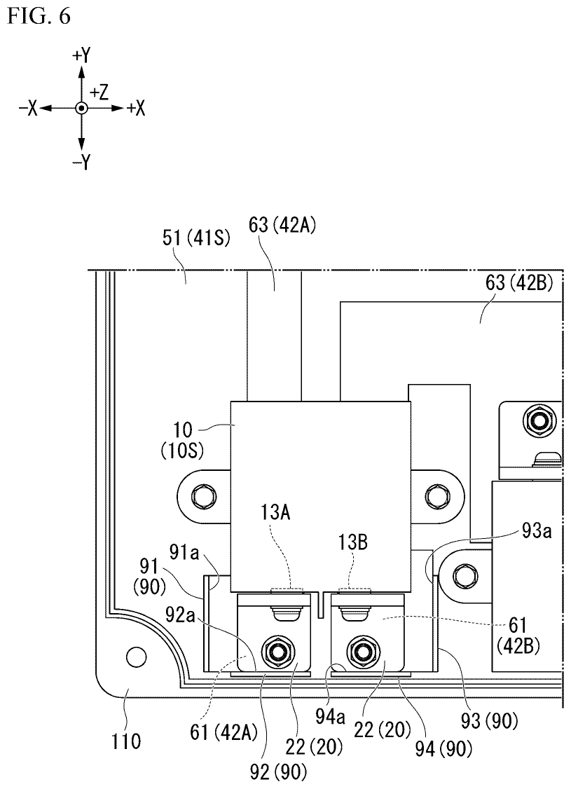

FIG. 6 is a partially exploded perspective view illustrating the routing board 40S. Hereinafter, for convenience of description, the base plate 41S, the bus bar 42, and the fastening member 43 will be described with reference to the drawings in which the routing board 40S is partially exploded.

### 4.3.1 Base Plate

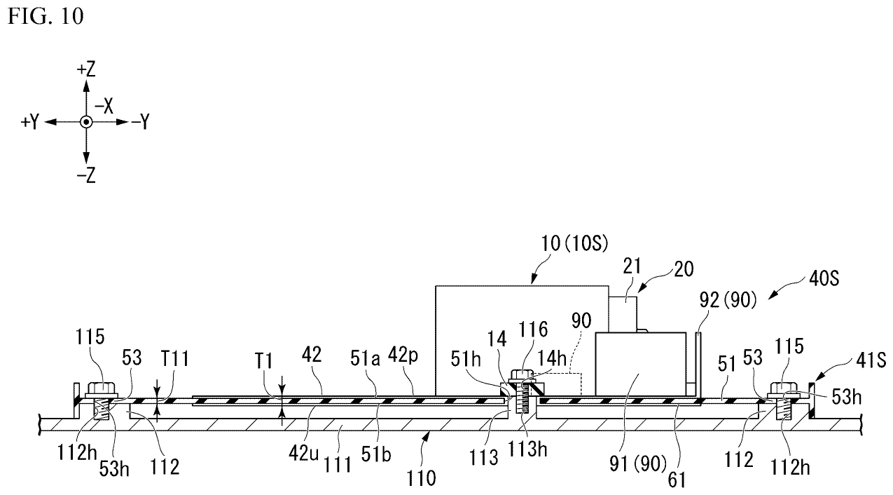

The base plate 41S is a support member that integrally supports the plurality of bus bars 42 arranged at intervals in the horizontal direction. The base plate 41S is made of, for example, a synthetic resin and has an insulating property. The base plate 41S electrically insulates the plurality of bus bars 42 from each other. The base plate 41S is an example of a “base member”. The base plate 41S may be referred to as an “insulating substrate”. The base plate 41S includes, for example, a flat surface portion 51, a frame portion 52, and a plurality of fixing portions 53 (see FIG. 10).

### (Flat Surface Portion)

The flat surface portion 51 is a portion formed in a plate shape in the base plate 41S. The flat surface portion 51 has a plate shape formed in the horizontal direction. The flat surface portion 51 forms a main portion of the base plate 41S. The flat surface portion 51 forms a base portion (insulating base portion) of the base plate 41S. In the present embodiment, the flat surface portion 51 extends over the entire width in the X direction of the base plate 41S and over the entire width in the Y direction of the base plate 41S except for the frame portion 52 of the base plate 41S.

The flat surface portion 51 has a first surface 51a and a second surface 51b (see FIG. 10). The first surface 51a is a surface directed in the +Z direction. The first surface 51a is a flat surface provided in the horizontal direction. The first surface 51a faces the plurality of electronic components 10 (for example, the plurality of electronic components 10S). The first surface 51a is an example of a “surface”. The second surface 51b is located on the side opposite to the first surface 51a. The second surface 51b is a surface directed in the −Z direction. The second surface 51b is a flat surface provided in the horizontal direction. The second surface 51b faces the metal plate 110 (see FIG. 2). A thickness direction (plate thickness direction) of the flat surface portion 51 is the Z direction. In the present embodiment, a thickness T11 of the flat surface portion 51 in the Z direction is smaller than a thickness T1 of the bus bar 42 in the Z direction (for example, a thickness of a horizontal plate portion 42p that will be described later in the Z direction) (see FIG. 10). The thickness T11 of the flat surface portion 51 in the Z direction may be equal to the thickness T1 of the bus bar 42 in the Z direction, or may be larger than the thickness T1 of the bus bar 42 in the Z direction.

The flat surface portion 51 has, for example, one or more (for example, a plurality of) accommodation portions 55 in which the bus bars 42 are accommodated, respectively. The plurality of accommodation portions 55 are formed apart from each other in the X direction or the Y direction. Each of the accommodation portions 55 is, for example, a through-hole penetrating the flat surface portion 51 in the Z direction. Note that the accommodation portion 55 may be a recess provided on the first surface 51a or the second surface 51b of the flat surface portion 51 and recessed in the Z direction, instead of a through-hole. In the present disclosure, the phrase “the accommodation portion penetrates the flat surface portion in the first direction (Z direction)” may include a case where a part of the entire length of the accommodation portion 55 penetrates the flat surface portion 51 in the Z direction (for example, the remaining portion of the accommodation portion 55 may be a recess recessed in the Z direction, or may be provided inside the base plate 41S and not exposed to the outside of the base plate 41S). Similarly, in the present disclosure, the phrase “the accommodation portion is recessed in the first direction (Z direction)” may include a case where a part of the entire length of the accommodation portion 55 is recessed in the Z direction (for example, a remaining portion of the accommodation portion 55 may be a through-hole penetrating the flat surface portion 51 in the Z direction, or may be provided inside the base plate 41S and not exposed to the outside of the base plate 41S).

Each accommodation portion 55 has an outer shape corresponding to the shape of the bus bar 42 to be accommodated when viewed from the Z direction. The plurality of accommodation portions 55 include, for example, four accommodation portions 55A, 55B, 55C, and 55D. The accommodation portion 55A is provided to correspond to a bus bar 42A that will be described later, and accommodates at least a part of the bus bar 42A. The accommodation portion 55B is provided to correspond to a bus bar 42B that will be described later, and accommodates at least a part of the bus bar 42B. The accommodation portion 55C is provided to correspond to a bus bar 42C that will be described later, and accommodates at least a part of the bus bar 42C. The accommodation portion 55D is provided to correspond to a bus bar 42D that will be described later, and accommodates at least a part of the bus bar 42D.

### (Frame Portion)

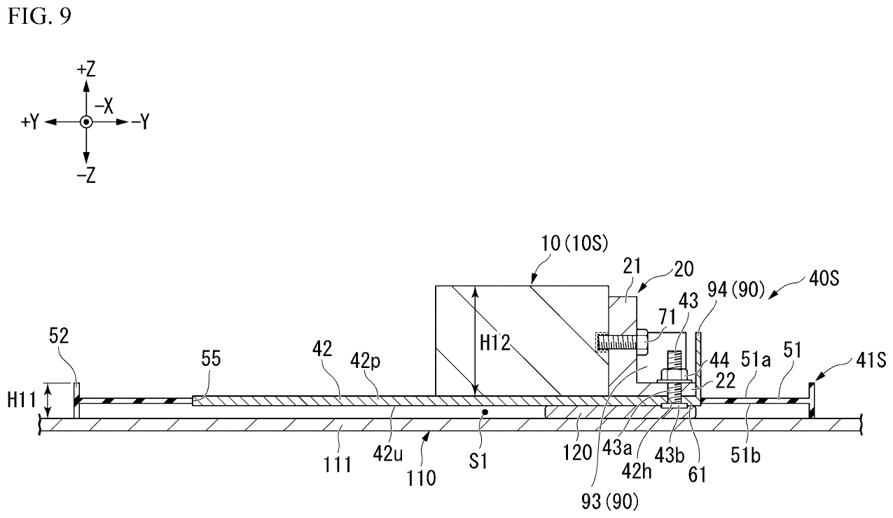

The frame portion 52 is provided at a peripheral end of the base plate 41S. The frame portion 52 is a reinforcement rib protruding vertically from an end of the flat surface portion 51 (see FIG. 9). A width (thickness) H11 of the frame portion 52 in the Z direction is, for example, less than half of a width (thickness) H12 of the electronic component 10 in the Z direction (see FIG. 9). Note that the frame portion 52 may be omitted.

### (Fixing Portion)

The fixing portion 53 is a portion fixed to the metal plate 110 (see FIG. 10). The fixing portion 53 has an attachment hole 53h penetrating the base plate 41S in the Z direction. A fastening member 115 (for example, a screw or a bolt) that will be described later passes through the attachment hole 53h. This content will be described later.

### 4.3.2 Bus Bar

The bus bar 42 is a routing member (electrical connection member) included in the routing board 40S. The bus bar 42 is, for example, a routing member for electrically connecting a plurality of electronic components (for example, a plurality of electronic components 10S). Alternatively, the bus bar 42 may be a routing member for electrically connecting the electronic component 10 (for example, the electronic component 10S) to the electronic component 10 included in another subunit SU (for example, the subunit SUT). The bus bar 42 is made of metal (for example, made of copper, made of a copper alloy, made of aluminum, or made of an aluminum alloy), and has a conductivity and a heat transfer property. As illustrated in FIG. 3, in the present embodiment, a plurality of bus bars 42 include, for example, four bus bars 42A, 42B, 42C, and 42D. The four bus bars 42A, 42B, 42C, and 42D are disposed to be arranged at intervals in the horizontal direction. The four bus bars 42A, 42B, 42C, and 42D include portions disposed on the same plane. The four bus bars 42A, 42B, 42C, and 42D are supported by the flat surface portion 51 of the base plate 41S. In the present disclosure, the phrase “the bus bar is supported by the flat surface portion” is not limited to the case where the bus bar 42 is accommodated in the accommodation portion 55, and may include a case where the bus bar 42 is attached to the first surface 51a or the second surface 51b of the flat surface portion 51.

As illustrated in FIG. 5, at least a part of each bus bar 42 has a plate shape formed in the horizontal direction. At least a part of each bus bar 42 is accommodated in the accommodation portion 55 and extends along the flat surface portion 51. That is, at least a part of each bus bar 42 extends along the first surface 51a of the flat surface portion 51. At least a part of each bus bar 42 extends in the horizontal direction in the accommodation portion 55. Hereinafter, a portion of each bus bar 42 extending in a plate shape formed in the horizontal direction may be referred to as a “horizontal plate portion 42p”. The horizontal plate portion 42p is an example of a “plate portion”. The bus bar 42 is a member that forms a horizontal energization path. The bus bar 42 may be referred to as a “horizontal routing member”.

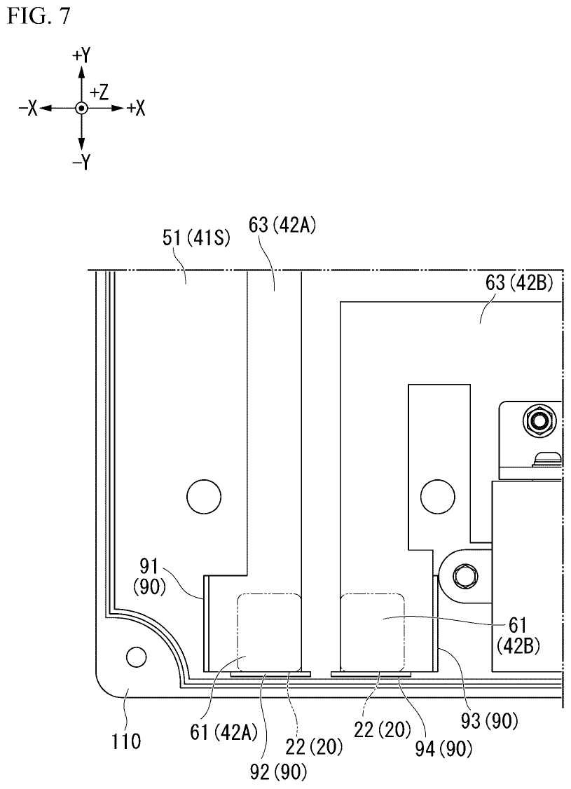

Each bus bar 42 includes, for example, a connection portion 61, a connection portion 62, and an extending portion 63. The connection portion 61 is located in the middle of the bus bar 42 or at the first end of the bus bar 42. The connection portion 61 is a portion connected to the electronic component 10 (for example, the electronic component 10S) directly or via the connection component 20. As illustrated in FIGS. 6 and 7, the connection portion 61 may include, for example, a portion overlapping the second portion 22 of the connection component 20 when viewed from the Z direction.

The connection portion 61 may include, for example, a portion in direct contact with the second portion 22 of the connection component 20. The connection portion 61 is adjacent to the connection component 20 in the Z direction and is connected to the connection component 20 from the Z direction.

The bus bar 42A is an example of a “first bus bar”. The horizontal plate portion 42p of the bus bar 42A is an example of a “first plate portion” . The connection portion 61 of the bus bar 42A is an example of a “first connection portion”.

The bus bar 42B is an example of a “second bus bar”. The horizontal plate portion 42p of the bus bar 42B is an example of a “second plate portion”. The connection portion 61 of the bus bar 42B is an example of a “second connection portion”.

Instead of the above example, for example, the connection portion 61 may be adjacent to the terminal 13 of the electronic component 10 in the Z direction and directly connected to the terminal 13 of the electronic component 10 from the Z direction. At that time, the connection portion 61 may include, for example, a portion overlapping the terminal 13 when viewed from the Z direction. The connection portion 61 may include, for example, a portion in direct contact with the terminal 13.

The connection portion 62 is located in the middle of the bus bar 42 or at the second end of the bus bar 42. The connection portion 62 is a portion connected to another electronic component 10 directly or via another connection component 20.

Instead of the above example, the connection portion 62 may be connected to another bus bar 42 (for example, the bus bar 42 included in another subunit SU) or an external connection bus bar.

The extending portion 63 extends from the connection portion 61 in the X direction or the Y direction. The extending portion 63 is provided between the connection portion 61 and the connection portion 62. The extending portion 63 extends over the connection portion 61 and the connection portion 62. The extending portion 63 connects the connection portion 61 to the connection portion 62.

In the present embodiment, the horizontal plate portion 42p described above includes at least the entire connection portion 61 and a part of the extending portion 63. That is, at least the entire connection portion 61 and a part of the extending portion 63 are accommodated in the accommodation portion 55 and located on the same plane.

In the present embodiment, the extending portions 63 of some of the bus bars 42 are accommodated in the accommodation portion 55, thereby passing through a region overlapping the electronic component 10 when viewed from the Z direction and extending over both sides of the region overlapping the electronic component 10. For example, the extending portion 63 extends over the region overlapping the electronic component 10 when viewed from the Z direction, over a −Y direction side and a +Y direction side of the region overlapping the electronic component 10. That is, the bus bar 42 is accommodated in the accommodation portion 55 to be easily routed through a better path (for example, a path with a shorter distance) without being disturbed by the presence of the electronic component 10.

One or more bus bars 42 may have an extension 64 in addition to the connection portion 61, the connection portion 62, and the extending portion 63. The extension 64 is a portion where the bus bar 42 extends for the purpose of increasing a heat dissipation area and/or increasing a heat capacity for heat storage (heat absorption). The extension 64 is a portion that is not used for electrical connection. For example, the extension 64 is located on the side opposite to the extending portion 63 with respect to the connection portion 61 (or the connection portion 62). The extension 64 has a plate shape formed in the horizontal direction. The extension 64 is included in the horizontal plate portion 42p. The extension 64 is accommodated in the accommodation portion 55 and extends along the flat surface portion 51. The extension 64 extends to a region overlapping the electronic component 10 when viewed from the Z direction, and has an end 42e1 of the bus bar 42 at a position overlapping the electronic component 10 when viewed from the Z direction.

### (Bent Portion)

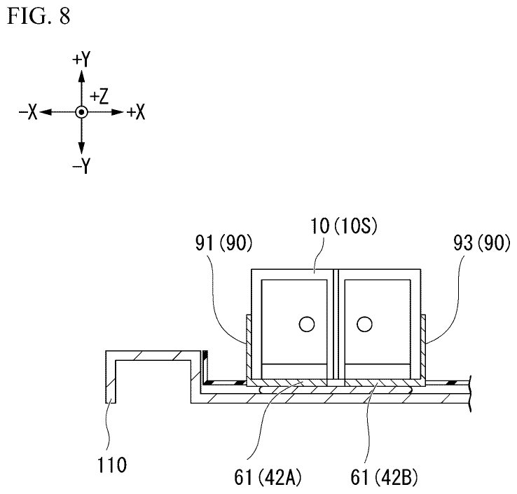

As illustrated in FIGS. 6 to 8, the bus bar 42A and the bus bar 42B further include a plurality of bent portions 90. The bus bar 42A further includes a first bent portion 91 and a second bent portion 92 as a pair of bent portions 90 among the plurality of bent portions 90. The bus bar 42B further includes a third bent portion 93 and a fourth bent portion 94 as another pair of bent portions 90 among the plurality of bent portions 90. When viewed from the Z direction, the plurality of bent portions 90 may surround, for example, the pair of connection portions 61 related to the nearest electronic component 10S from three direction sides (the +X direction side, the −X direction side, and the −Y direction side). When viewed from the Z direction, the plurality of bent portions 90 may surround, for example, the pair of connection components 20 related to the nearest electronic component 10S from three direction sides (the +X direction side, the −X direction side, and the −Y direction side).

The first bent portion 91 is located near the nearest electronic component 10S among the plurality of electronic components 10S and near the connection portion 61 corresponding to the electronic component 10S related to the nearest electronic component 10S. The first bent portion 91 is bent in the +Z direction from an edge on the −X direction side of the horizontal plate portion 42p of the bus bar 42A at a position aligned in the X direction with the connection portion 61 of the bus bar 42A. For example, the first bent portion 91 may be bent in an L shape and at a right angle when viewed from the Y direction from the edge on the −X direction side of the horizontal plate portion 42p of the bus bar 42A. The first bent portion 91 is aligned in the −X direction with respect to the nearest connection component 20 (the connection component 20 connected to the terminal 13A of the nearest electronic component 10S) and the nearest electronic component 10S. The interval between the first bent portion 91 and the nearest electronic component 10S in the X direction may be smaller than, for example, the width of the nearest electronic component 10S in the alignment direction (for example, the X direction). The interval between the first bent portion 91 and the nearest electronic component 10S in the X direction may be smaller than, for example, ½ of the width of the electronic component 10S in the alignment direction (for example, the X direction). On the other hand, the interval between the first bent portion 91 and the nearest connection component 20 in the X direction may be smaller than, for example, the width of the nearest connection component 20 in the alignment direction (for example, the X direction). The interval between the first bent portion 91 and the nearest connection component 20 in the X direction may be smaller than, for example, ½ of the width of the nearest connection component 20 in the alignment direction (for example, the X direction). The interval between the first bent portion 91 and the nearest connection component 20 in the X direction may be smaller than, for example, ¼ of the width of the nearest connection component 20 in the alignment direction (for example, the X direction).

The first bent portion 91 extends in the Z direction by a length not exceeding the height of the nearest electronic component 10S. The first bent portion 91 has a first bent surface 91a directed in the +X direction. At least a part of the first bent surface 91a faces, for example, a surface directed in the −X direction of the nearest electronic component 10S and a surface directed in the −X direction of the nearest connection component 20 at an interval in the X direction. At least a part of the first bent surface 91a directly faces, for example, a surface directed in the −X direction of the nearest electronic component 10S and a surface directed in the −X direction of the nearest connection component 20 without another member interposed therebetween. The first bent surface 91a may be, for example, a flat surface.

Among the plurality of electronic components 10S, the second bent portion 92 is located near the nearest electronic component 10S and near the connection portion 61 corresponding to the electronic component 10S related to the nearest electronic component 10S. The second bent portion 92 is bent in the +Z direction from the edge on the −Y direction-side of the horizontal plate portion 42p of the bus bar 42A at a position aligned with the connection portion 61 of the bus bar 42A in the Y direction. For example, the second bent portion 92 may be bent in an L shape and at a right angle when viewed from the X direction from the edge on the −Y direction side of the horizontal plate portion 42p of the bus bar 42A. The second bent portion 92 is aligned in the −Y direction with respect to the nearest connection component 20 (the connection component 20 connected to the terminal 13A of the nearest electronic component 10S) and the nearest electronic component 10S. The interval between the second bent portion 92 and the nearest electronic component 10S in the Y direction may be smaller than, for example, the width (for example, the length L11; and see FIG. 4) of the electronic component 10S in the alignment direction (for example, the Y direction). The interval between the second bent portion 92 and the nearest electronic component 10S in the Y direction may be smaller than, for example, ½ of the width of the electronic component 10S in the alignment direction (for example, the Y direction). On the other hand, the interval between the second bent portion 92 and the nearest connection component 20 in the Y direction may be smaller than, for example, the width (for example, the length L12; and see FIG. 4) of the nearest connection component 20 in the alignment direction (for example, the Y direction). The interval between the second bent portion 92 and the nearest connection component 20 in the Y direction may be smaller than, for example, ½ of the width of the nearest connection component 20 in the alignment direction (for example, the Y direction). The interval between the second bent portion 92 and the nearest connection component 20 in the Y direction may be smaller than, for example, ¼ of the width of the nearest connection component 20 in the alignment direction (for example, the Y direction).

The second bent portion 92 extends in the Z direction by a length not exceeding the height of the nearest electronic component 10S. The second bent portion 92 has a second bent surface 92a directed in the +Y direction. At least a part of the second bent surface 92a faces, for example, a surface directed in the −Y direction of the nearest electronic component 10S and a surface directed in the −Y direction of the nearest connection component 20 at an interval in the Y direction. At least a part of the second bent surface 92a directly faces, for example, a surface directed in the −Y direction of the nearest electronic component 10S and a surface directed in the −Y direction of the nearest connection component 20 without another member interposed therebetween. The second bent surface 92a may be, for example, a flat surface.

The third bent portion 93 is located near the nearest electronic component 10S among the plurality of electronic components 10S and near the connection portion 61 related to the nearest electronic component 10S. The third bent portion 93 is bent in the +Z direction from the edge on the +X direction side of the horizontal plate portion 42p of the bus bar 42B at a position aligned with the connection portion 61 of the bus bar 42B in the X direction. For example, the third bent portion 93 may be bent in an L shape and at a right angle when viewed from the Y direction from the edge on the +X direction side of the horizontal plate portion 42p of the bus bar 42B. The third bent portion 93 is aligned in the +X direction with respect to the nearest connection component 20 (the connection component 20 connected to the terminal 13B of the nearest electronic component 10S) and the nearest electronic component 10S. The interval between the third bent portion 93 and the nearest electronic component 10S in the X direction may be smaller than, for example, the width of the nearest electronic component 10S in the alignment direction (for example, the X direction). The interval between the third bent portion 93 and the nearest electronic component 10S in the X direction may be smaller than, for example, ½ of the width of the electronic component 10S in the alignment direction (for example, the X direction). On the other hand, the interval between the third bent portion 93 and the nearest connection component 20 in the X direction may be smaller than, for example, the width of the nearest connection component 20 in the alignment direction (for example, the X direction). The interval between the third bent portion 93 and the nearest connection component 20 in the X direction may be smaller than, for example, ½ of the width of the nearest connection component 20 in the alignment direction (for example, the X direction). The interval between the third bent portion 93 and the nearest connection component 20 in the X direction may be smaller than, for example, ¼ of the width of the nearest connection component 20 in the alignment direction (for example, the X direction).

The third bent portion 93 extends in the Z direction by a length not exceeding the height of the nearest electronic component 10S. The third bent portion 93 has a third bent surface 93a directed in the −X direction. At least a part of the third bent surface 93a faces, for example, a surface directed in the +X direction of the nearest electronic component 10S and a surface directed in the +X direction of the nearest connection component 20 at an interval in the X direction. For example, at least a part of the third bent surface 93a directly faces a surface directed in the +X direction of the nearest electronic component 10S and a surface directed in the +X direction of the nearest connection component 20 without another member interposed therebetween. The third bent surface 93a may be, for example, a flat surface parallel to the first bent surface 91a.

Among the plurality of electronic components 10S, the fourth bent portion 94 is located near the nearest electronic component 10S and near the connection portion 61 related to the nearest electronic component 10S. The fourth bent portion 94 is bent in the +Z direction from the edge on the −Y direction-side of the horizontal plate portion 42p of the bus bar 42B at a position aligned with the connection portion 61 of the bus bar 42B in the Y direction. For example, the fourth bent portion 94 may be bent in an L shape and at a right angle when viewed from the X direction from the edge on the −Y direction side of the horizontal plate portion 42p of the bus bar 42B. The fourth bent portion 94 is aligned in the −Y direction with respect to the nearest connection component 20 (the connection component 20 connected to the terminal 13B of the nearest electronic component 10S) and the nearest electronic component 10S. The interval between the fourth bent portion 94 and the nearest electronic component 10S in the Y direction may be smaller than, for example, the width of the nearest electronic component 10S in the alignment direction (for example, the Y direction). The interval between the fourth bent portion 94 and the nearest electronic component 10S in the Y direction may be smaller than, for example, ½ of the width of the electronic component 10S in the alignment direction (for example, the Y direction). On the other hand, the interval between the fourth bent portion 94 and the nearest connection component 20 in the Y direction may be smaller than, for example, the width of the nearest connection component 20 in the alignment direction (for example, the Y direction). The interval between the fourth bent portion 94 and the nearest connection component 20 in the Y direction may be smaller than, for example, ½ of the width of the nearest connection component 20 in the alignment direction (for example, the Y direction). The interval between the fourth bent portion 94 and the nearest connection component 20 in the Y direction may be smaller than, for example, ¼ of the width of the nearest connection component 20 in the alignment direction (for example, the Y direction).

The fourth bent portion 94 extends in the Z direction by a length not exceeding the height of the nearest electronic component 10S. The fourth bent portion 94 has a fourth bent surface 94a directed in the +Y direction. At least a part of the fourth bent surface 94a faces, for example, a surface directed in the −Y direction of the nearest electronic component 10S and a surface directed in the −Y direction of the nearest connection component 20 at an interval in the Y direction. For example, at least a part of the fourth bent surface 94a directly faces a surface directed in the −Y direction of the nearest electronic component 10S and a surface directed in the −Y direction of the nearest connection component 20 without another member interposed therebetween. The fourth bent surface 94a may be, for example, a flat surface parallel to the second bent surface 92a.

When the plurality of bent portions 90 are provided, the height of the routing structure 40T in the Z direction may be constituted to be larger than the height of the routing board 40S in the Z direction. By providing a difference in height between the routing board 40S and the routing structure 40T, a sufficient space in which air easily flows is formed above the routing board 40S. In addition, by constituting the routing board 40S to be thinner than the routing structure 40T, it is easy to provide the plurality of bent portions 90 and to allow the plurality of bent portions 90 to extend in the Z direction.

### (Exposure Structure on Upper Surface Side of Each Bus Bar)

In the present embodiment, at least a part of the bus bar 42 is exposed to the upper surface side of the base plate 41S. For example, the connection portion 61, the connection portion 62, and the extending portion 63 of the bus bar 42 are exposed to the outside of the base plate 41S on the upper surface side (the first surface 51a side of the flat surface portion 51) of the base plate 41S. For example, the extending portion 63 of the bus bar 42 is exposed to the outside of the base plate 41S on the upper surface side of the base plate 41S at least over the entire length between the connection portion 61 and the connection portion 62.

### (Exposure Structure on Lower Surface Side of Each Bus Bar)

In the present embodiment, at least a part of the bus bar 42 is exposed to the lower surface side of the base plate 41S. For example, the entire connection portion 61 and at least a part of the extending portion 63 are exposed to the outside of the base plate 41S on the lower surface side of the base plate 41S (the second surface 51b side of the flat surface portion 51). In the present embodiment, a gap S1 is formed between the flat surface portion 51 of the base plate 41S and the metal plate 110 (see FIG. 9). The bus bar 42 includes an exposed portion 42u exposed to the gap S1 (see FIG. 9). The exposed portion 42u includes, for example, the entire connection portion 61 and at least a part of extending portion 63.

### 4.3.3 Fastening Member

Next, the fastening member 43 will be described.

As illustrated in FIG. 9, the fastening member 43 is a component for fixing the bus bar 42 to the connection component 20 corresponding to the bus bar 42. The fastening member 43 is, for example, a caulking bolt fixed to the bus bar 42. The fastening member 43 is an example of a “fastening portion”.

In the present embodiment, at least one of the connection portion 61 and the connection portion 62 of the bus bar 42 has a through-hole 42h. The through-hole 42h penetrates the bus bar 42 in the Z direction. The fastening member 43 is, for example, a bolt having a shaft 43a and a head 43b. A circumferential surface of the shaft 43a has a screw groove. The head 43b has a diameter larger than that of the shaft 43a. The head 43b of the fastening member 43 is caulked and fixed to the bus bar 42 in a state in which the shaft 43a passes through the through-hole 42h of the bus bar 42. With this fixation, the fastening member 43 is electrically and physically connected to the bus bar 42 in a state in which the shaft 43a protrudes in the +Z direction from the through-hole 42h of the bus bar 42. The fastening member 43 is not limited to caulking fixation, and may be fixed to the bus bar 42 through welding or other methods.

In the present embodiment, the connection component 20 is attached to the fastening member 43 from the Z direction in a state of being previously fixed to the electronic component 10 via the fastening member 71. For example, in the connection component 20, the shaft 43a of the fastening member 43 is inserted into the second attachment hole 22h of the second portion 22. The engagement member 44 (for example, a nut) is engaged with the shaft 43a of the fastening member 43 protruding from the second attachment hole 22h of the second portion 22 of the connection component 20.

The engagement member 44 is attached to the shaft 43a in the Z direction. This engagement fixes the second portion 22 of the connection component 20 to the fastening member 43.

### 5. HEAT TRANSFER MEMBER

First, the Heat Transfer Member 120 Will Be Described.

The heat transfer member 120 is a member for transferring heat generated by the electronic component 10 (for example, the electronic component 10S) at the time of energization and/or heat (Joule heat) generated by the bus bar 42 itself at the time of energization to the metal plate 110. The heat transfer member 120 is, for example, a heat transfer sheet (for example, a thermally conductive silicone sheet) having elasticity. The heat transfer member 120 is made of a material having higher thermal conductivity than the base plate 41S (or the base member 41T), for example. However, the heat transfer member 120 is not limited to the above example, and may be a heat transfer member formed of a thermally conductive gel or another material. In the present embodiment, the heat transfer member 120 has an insulating property.

In the present embodiment, the heat transfer member 120 is partially provided in the routing board 40S (see FIG. 2). For example, the heat transfer member 120 is disposed at a position overlapping a part of the bus bar 42 when viewed from the Z direction. The heat transfer member 120 is disposed between the bus bar 42 and a flat surface portion 111 of the metal plate 110 that will be described later. For example, the heat transfer member 120 is disposed between the exposed portion 42u of the bus bar 42 and the flat surface portion 111 of the metal plate 110, and is in contact with the exposed portion 42u of the bus bar 42 and the flat surface portion 111 of the metal plate 110. The heat transfer member 120 transfers heat transferred from the electronic component 10 (for example, the electronic component 10S) to the bus bar 42 and/or heat generated by the bus bar 42 from the bus bar 42 to the flat surface portion 111 of the metal plate 110.

In the present embodiment, the heat transfer member 120 is disposed at a position overlapping a part of the bus bar 42 in the vicinity of the electronic component 10 (for example, the electronic component 10S) when viewed from the Z direction. In the present embodiment, the heat transfer member 120 is disposed at a position overlapping the connection component 20 when viewed from the Z direction. In other words, the heat transfer member 120 is disposed at a position overlapping the connection portion 61 or the connection portion 62 of the bus bar 42 when viewed from the Z direction. The heat transfer member 120 transfers heat transferred from the electronic component 10S to the bus bar 42 via the connection component 20 from the bus bar 42 to the flat surface portion 111 of the metal plate 110.

### 6. FIXING STRUCTURE OF ROUTING BOARD AND ELECTRONIC COMPONENT

Next, a fixing structure of the routing board 40S and the electronic component 10 will be described.

As illustrated in FIG. 10, the metal plate 110 includes, for example, a fixing portion 112 and a fixing portion 113 in addition to a flat surface portion 111 that will be described later.

The fixing portion 112 is a fixing portion for fixing the base plate 41S to the metal plate 110. The fixing portion 112 is provided at a position corresponding to the fixing portion 53 of the base plate 41S when viewed from the Z direction. The fixing portion 112 is a cylindrical or prismatic boss protruding in the +Z direction from the flat surface portion 111 of the metal plate 110. The fixing portion 112 has an engagement hole 112h that is open in the +Z direction. An inner circumferential surface of the engagement hole 112h has a screw groove.

As described above, the fixing portion 53 of the base plate 41S has an attachment hole 53h. A fastening member 115 (for example, a screw or a bolt) passes through the attachment hole 53h. When the fastening member 115 that has passed through the attachment hole 53h of the fixing portion 53 of the base plate 41S is engaged with the engagement hole 112h of the fixing portion 112 of the metal plate 110, the base plate 41S is fixed to the metal plate 110.

The fixing portion 113 is a fixing portion for directly fixing the electronic component 10 (for example, the electronic component 10S) to the metal plate 110 without the base plate 41S interposed therebetween. The fixing portion 113 is provided at a position corresponding to the attachment portion 14 of the electronic component 10 when viewed from the Z direction. The fixing portion 113 is a cylindrical or prismatic boss protruding in the +Z direction from the flat surface portion 111. The fixing portion 113 has an engagement hole 113h that is open in the +Z direction. An inner circumferential surface of the engagement hole 113h has a screw groove.

In the present embodiment, the flat surface portion 51 of the base plate 41S has a through-hole 51h. The through-hole 51h penetrates the flat surface portion 51 in the Z direction. The through-hole 51h is provided at a position corresponding to the fixing portion 113 of the metal plate 110 when viewed from the Z direction. The fixing portion 113 of the metal plate 110 passes through the through-hole 51h of the base plate 41S and protrudes to the same position as the first surface 51a of the flat surface portion 51 or further toward the +Z direction side than the first surface 51a of the flat surface portion 51. The attachment portion 14 of the electronic component 10 is in contact with the fixing portion 113 at the same position as the first surface 51a of the flat surface portion 51 or at a position located further toward the +Z direction side than the first surface 51a of the flat surface portion 51.

A fastening member 116 (for example, a screw or a bolt) passes through the attachment hole 14h of the attachment portion 14 of the electronic component 10 from the +Z direction side. When the fastening member 116 that has passed through the attachment hole 14h of the attachment portion 14 of the electronic component 10 is engaged with the engagement hole 113h of the fixing portion 113 of the metal plate 110, the electronic component 10 is fixed to the metal plate 110 without the base plate 41S interposed therebetween. Note that, instead of the above-described example, the electronic component 10 may be fixed to a fixing portion provided in the base plate 41S.

### 8. METAL PLATE AND INSULATING COVER

Next, referring to FIG. 2 again, the metal plate 110 and the insulating cover 130 will be described.

### 8.1 Metal Plate

The metal plate 110 is a member that secures rigidity of the electrical connection unit 1 and enhances the heat dissipation property of the electrical connection unit 1. The metal plate 110 is made of metal (for example, aluminum or an aluminum alloy). The metal plate 110 is an example of a “rigid member”. The metal plate 110 may be referred to as a “metal member”or a “heat dissipation member”.

The metal plate 110 has a rectangular shape formed in the X direction and the Y direction. The metal plate 110 has a first end 110e1, a second end 110e2, a third end 110e3, and a fourth end 110e4. The first end 110e1 and the second end 110e2 are a pair of ends of the metal plate 110 in the longitudinal direction, and are separated in the X direction. The third end 110e3 and the fourth end 110e4 are a pair of ends of the metal plate 110 in the lateral direction, and are separated in the Y direction. The metal plate 110 includes, for example, the flat surface portion 111, the plurality of fixing portions 112 (see FIG. 10) described above, and the plurality of fixing portions 113 (see FIG. 10) described above.

The flat surface portion 111 is a portion formed in a plate shape in the metal plate 110. The flat surface portion 111 has a plate shape formed in the horizontal direction. The flat surface portion 111 forms a main portion of the metal plate 110. The flat surface portion 111 forms a base portion (metal base portion) of the metal plate 110. The flat surface portion 111 has a size that covers the two subunits SU from below.

In the present embodiment, the flat surface portion 111 has a first region A1 and a second region A2. The first region A1 is, for example, a region on the −Y direction side in the flat surface portion 111. The subunit SUS described above faces the first region A1 of the flat surface portion 111 when viewed from the Z direction. That is, the plurality of electronic components 10S and the base plate 41S included in the subunit SUS face the first region A1 of the flat surface portion 111 in the Z direction.

The second region A2 is, for example, a region on the +Y direction side in the flat surface portion 111. The above-described subunit SU faces the second region A2 of the flat surface portion 111 when viewed from the Z direction. That is, the plurality of electronic components 10T and the base member 41T included in the subunit SUT face the second region A2 of the flat surface portion 111 in the Z direction.

### 8.2 Insulating Cover

The insulating cover 130 is a member for preventing a user's finger from contacting the energization path of the subunit SU. The insulating cover 130 is made of, for example, a synthetic resin and has an insulating property. The insulating cover 130 has, for example, a box shape that is open on the-Z direction side. The insulating cover 130 has a plurality of vent holes 130h. The insulating cover 130 covers a part or the whole of the corresponding subunit SU. Note that the insulating cover 130 is not limited to a box-shaped member, and may be a sheet-shaped member that covers the energization path of the main body MU. The insulating cover 130 may be omitted.

### 9. ADVANTAGES

### A. Advantages Related to Bent Portion

The first bent portion 91 of the present embodiment is bent in the Z direction from the horizontal plate portion 42p at a position aligned with the connection portion 61. With this constitution, a partial space around the electronic component 10S can be effectively used for heat dissipation. Heat confined in the bus bar 42 near the electronic component 10S is stored in each bent portion 90. In addition, heat confined in the bus bar 42A near the electronic component 10S is dissipated to the surroundings of the electronic component 10S via the first bent portion 91. Therefore, the heat dissipation property can be improved.

The first bent portion 91 of the present embodiment extends in the Z direction. With this constitution, a space extending in the Z direction around the electronic component 10S can be effectively used for heat dissipation. Therefore, the heat dissipation property can be improved.

The second bent portion 92 of the present embodiment is bent in the Z direction at a position aligned with the connection portion 61. The second bent portion 92 intersects the direction in which the first bent portion 91 is directed. With this constitution, among some spaces around the electronic component 10S, a pair of spaces around the electronic component 10S, that is, a pair of spaces directed in directions intersecting each other can be effectively used for heat dissipation. The heat confined in the bus bar 42A near the electronic component 10S, is stored in the second bent portion 92. In addition, the heat confined in the bus bar 42A near the electronic component 10S is dissipated to the surroundings of the electronic component 10S via the second bent portion 92. Therefore, the heat dissipation property can be improved.

In the present embodiment, the second bent portion 92 is aligned in the Y direction with the connection component 20 connected to the terminal 13A. The first bent portion 91 is aligned in the X direction with the connection component 20 connected to the terminal 13A. With this constitution, among some of the spaces around the electronic component 10S, a space aligned with the connection component 20 in the Y direction and a space aligned with the connection component 20 in the X direction can be effectively used for heat dissipation. Therefore, the heat dissipation property can be improved.

In the present embodiment, the third bent portion 93 is bent in the Z direction at a position aligned with the connection portion 61. The fourth bent portion 94 is bent in the Z direction at a position aligned with the connection portion 61. With this constitution, spaces of other portions around the electronic component 10S can be more effectively used for heat dissipation. Heat confined in the bus bar 42B near the electronic component 10S is stored in the third bent portion 93 and the fourth bent portion 94. In addition, the heat confined in the bus bar 42B near the electronic component 10S is dissipated to the surroundings of the electronic component 10S via the third bent portion 93 and the fourth bent portion 94. Therefore, the heat dissipation property can be improved.

### B. Advantages Related to Plurality of Region Divisions in Electrical Connection Unit

As a comparative example, a constitution in which an electronic component of which a heat dissipation property is to be prioritized and an electronic component of which a mountability is to be prioritized are attached to one base member will be considered. In such a constitution, it may be difficult to improve the mountability when a thin base member is adopted, and it may be difficult to improve the heat dissipation property when a relatively thick base member is adopted.

On the other hand, in the electrical connection unit 1 of the present embodiment, the base member 41T of the routing structure 40T has a three-dimensional structure thicker in the Z direction than the base plate 41S of the routing board 40S.

According to such a constitution, by using the base plate 41S having the flat surface portion 51, it is possible to dispose the electronic component 10S in which the heat dissipation property is emphasized near the metal plate 110 and to promote heat release with the metal plate 110 as a heat dissipation member. On the other hand, by using the base member 41T having a three-dimensional structure thick in the Z direction, the electronic component 10T in which mountability is emphasized can be appropriately mounted. By using such regions properly, it is possible to provide the electrical connection unit 1 that achieves both the heat dissipation property and the mountability.

### 10. MODIFICATION EXAMPLES

Next, several modification examples will be described. Note that a constitution other than that described below in each modification example is the same as the constitution of the above-described embodiment.

### First Modification Example

In the above embodiment, the terminal 13A is an example of a “first terminal”. The terminal 13B is an example of a “second terminal”. However, the first terminal and the second terminal may be any pair of terminals as long as the terminals are a pair of terminals included in the electronic component 10S. As a modification example, the terminal 13A may be an example of a “second terminal”. The terminal 13B may be an example of a “first terminal”.

### Second Modification Example

In the above embodiment, the bus bar 42A is an example of a “first bus bar”.

The bus bar 42B is an example of a “second bus bar”. However, the first bus bar and the second bus bar may be any pair of bus bars as long as the bus bars are a pair of bus bars electrically connected to the electronic component 10S. As a modification example, the bus bar 42A may be an example of a “second bus bar”. The bus bar 42B may be an example of a “first bus bar”.

### Third Modification Example

In the above embodiment, the horizontal plate portion 42p of the bus bar 42A is an example of a “first plate portion”. The horizontal plate portion 42p of the bus bar 42B is an example of a “second plate portion”. However, each of the first plate portion and the second plate portion may be any plate portion as long as a corresponding bus bar includes the plate portion. As a modification example, the horizontal plate portion 42p of the bus bar 42A may be an example of a “second plate portion”. The horizontal plate portion 42p of the bus bar 42B may be an example of a “first plate portion”.

### Fourth Modification Example

In the above embodiment, the connection portion 61 of the bus bar 42A is an example of a “first connection portion”. The connection portion 61 of the bus bar 42B is an example of a “second connection portion”. However, each of the first connection portion and the second connection portion may be any connection portion as long as a corresponding bus bar includes the connection portion. As a modification example, the connection portion 61 of the bus bar 42A may be an example of a “second connection portion”. The connection portion 61 of the bus bar 42B may be an example of a “first connection portion”.

### Fifth Modification Example

In the above embodiment, the connection portion 61 of the bus bar 42A is an example of a “first connection portion”. The connection portion 61 of the bus bar 42B is an example of a “second connection portion”. However, each of the first connection portion and the second connection portion may be either one of the connection portions 61 and 62 of any bus bar 42 as long as a corresponding bus bar includes the connection portion. As a modification example, the connection portion 61 or the connection portion 62 of any bus bar 42 among the plurality of bus bars 42 may be an example of a “first connection portion”. The connection portion 61 or the connection portion 62 of another bus bar among the plurality of bus bars may be an example of a “second connection portion”.

### Sixth Modification Example

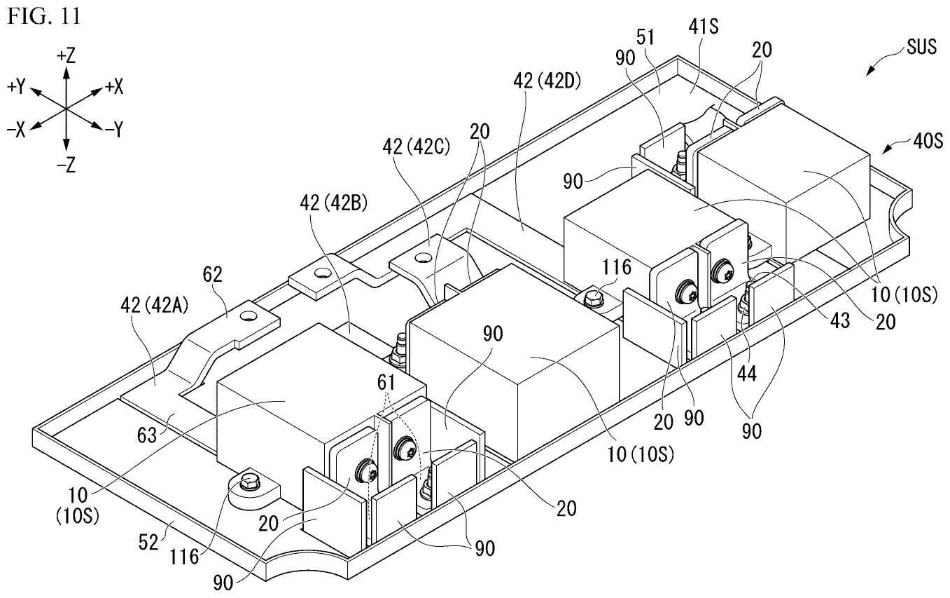

Positions at which the plurality of bent portions 90 are provided are not limited to the position aligned with the connection portion 61 of the bus bar 42A and the position aligned with the connection portion 61 of the bus bar 42B. As a modification example, as illustrated in FIG. 11, positions where the plurality of bent portions 90 are provided may include a position aligned with the connection portion 61 of the bus bar 42C and a position aligned with the connection portion 61 of the bus bar 42D in addition to the position aligned with the connection portion 61 of the bus bar 42A and the position aligned with the connection portion 61 of the bus bar 42B.

### Seventh Modification Example

The routing board 40S is not limited to a structure in which the base plate 41S and the bus bar 42 are integrated through insert molding. For example, the bus bar 42 may be disposed in the accommodation portion 55 after the base plate 41S provided with the accommodation portion 55 accommodating the bus bar 42 is molded. In this case, the bus bar 42 may be fixed to the accommodation portion 55 through fitting, or may be fixed to the accommodation portion 55 via an adhesive or other fixing means. In these cases, potting may be performed to fill a gap between the bus bar 42 and the accommodation portion 55.

### Eighth Modification Example

The base member of the routing board 40S is not limited to the base plate 41S having the plate-shaped flat surface portion 51. The routing board 40S may be a base member (for example, an insulating sheet) having a sheet-shaped flat surface portion 51. In this case, the accommodation portion 55 may be formed by a part of the flat surface portion 51 following the outer shape of the bus bar 42. In the present disclosure, the “sheet-shaped” or “sheet” is not limited to a member having a thickness of 1 mm or more, and a member (so-called a film) having a thickness of less than 1 mm can also be used.

### Ninth Modification Example

The base plate 41S of the routing board 40S may include a plurality of members (plate members or sheet members). The plurality of members are provided to sandwich the plurality of bus bars 42 arranged in the horizontal direction. For example, the plurality of members are integrated by sandwiching the plurality of bus bars 42 through laminate molding, for example. The plurality of members form the flat surface portion 51. In this case, the accommodation portion 55 may be formed in a hollow shape inside the base plate 41S (between the plurality of members). The plurality of members may be a plurality of plate members, a plurality of sheet members, or a combination of a plate member and a sheet member. The sheet member may be, for example, a flexible sheet member. The flat surface portion 51 formed of the plurality of members has an opening to which at least the connection portion 61 and the connection portion 62 of the bus bar 42 are exposed.

### Tenth Modification Example

A connection between the electronic component 10 and the bus bar 42 is not limited to the connection using the connection component 20. The electronic component 10 may be directly connected to the bus bar 42 by using a fastening member (for example, a bolt or a screw), welding, or the like.

Several embodiments and modification examples have been described above. However, the embodiment and the modification examples are not limited to the examples described above. For example, the plurality of modification examples described above may be implemented in combination with each other.

### DESCRIPTION OF REFERENCE SYMBOLS

1 Electrical connection unit
5 Casing
6 Base
7 Cover portion
10 Electronic component
10S Electronic component
10T Electronic component
11 Case
11a Insulating rib
12 Component Body
13 Terminal
13A Terminal (first terminal)
13B Terminal (second terminal)
13h Attachment hole
14 Attachment portion
14h Attachment hole
20 Connection component
21 First portion
21h First attachment hole
22 Second portion
221 Second attachment hole
40 Routing structure
40S Routing board
40T Routing structure
41S Base plate (base member)
41T Base member
42 Bus bar
42A Bus bar (first bus bar)
42B Bus bar (second bus bar)
42C Bus bar
42D Bus bar
42e1 End
42h Through-hole
42p Horizontal plate portion (first plate portion, second plate portion)
42u Exposed portion
43 Fastening member
43a Shaft
43b Head
44 Engagement member
51 Flat surface portion
51a First surface (surface)
51b Second surface
51h Through-hole
52 Frame portion
53 Fixing portion
53h Attachment hole
55 Accommodation portion
55A Accommodation portion
55B Accommodation portion
55C Accommodation portion
55D Accommodation portion
61 Connection portion (first connection portion, second connection portion)
62 Connection portion
63 Extending portion
64 Extension
71 Fastening member
90 Bent portion
91 First bent portion
91a First bent surface
92 Second bent portion
92a Second bent surface
93 Third bent portion
93a Third bent surface
94 Fourth bent portion
94a Fourth bent surface
110 Metal plate
110e1 First end
110e2 Second end
110e3 Third end
110e4 Fourth end
111 Flat surface portion
112 Fixing portion
112h Engagement hole
113 Fixing portion
113h Engagement hole
115 Fastening member
116 Fastening member
120 Heat transfer member
130 Insulating cover
130h Vent hole
A1 First region
A2 Second region
H11 Width (thickness)
H12 Width (thickness)
MU Main body
R1 First region
R2 Second region
S1 Gap
SU Subunit
SUS Subunit
SUT Subunit

1. An electrical connection unit comprising:
an electronic component including a first terminal;
an insulating base member including a flat surface portion having a plate shape or a sheet shape and including a surface facing the electronic component; and
a first bus bar supported by the flat surface portion, electrically connected to the electronic component, and including a first plate portion and a first bent portion, wherein the first plate portion includes a first connection portion electrically connected to the first terminal, and
the first bent portion is bent from the first plate portion in a direction intersecting the surface at a position aligned with the first connection portion.

2. The electrical connection unit according to claim 1, wherein
in a case where a thickness direction of the flat surface portion is a first direction, the first bent portion extends in the first direction.

3. The electrical connection unit according to claim 1, wherein
the first bus bar further includes a second bent portion bent from the first plate portion in the direction intersecting the surface at the position aligned with the first connection portion, and
the second bent portion is directed in a direction intersecting a direction in which the first bent portion is directed.

4. The electrical connection unit according to claim 3, further comprising:
a connection component including a first portion fastened to the first terminal and a second portion fastened to the first connection portion, wherein
the second bent portion is aligned with the connection component in a second direction along the flat surface portion, and
the first bent portion is aligned with the connection component in a third direction intersecting the second direction along the flat surface portion.

5. The electrical connection unit according to claim 3, further comprising:
a second bus bar supported by the flat surface portion, electrically connected to the electronic component, and including a second plate portion, a third bent portion, and a fourth bent portion, wherein
the electronic component further includes a second terminal, and
the second plate portion includes a second connection portion electrically connected to the second terminal,
the third bent portion is bent from the second plate portion in a direction intersecting the surface at a position aligned with the second connection portion, and
the fourth bent portion is bent from the second plate portion in a direction intersecting the surface and is directed in a direction intersecting a direction in which the third bent portion is directed, at a position aligned with the second connection portion.
